(19) United States
(12) Patent Application Publication
(10) Pub. No.: US 2026/0237326 A1
(43) Pub. Date: Aug. 13, 2026

(54) DECORATIVE COVER FOR ALTERING A VISUAL APPEARANCE OF A PIECE OF WALL ART AND METHOD THEREFOR

(71) Applicant: Michelle Pierre, Liberty Hill, TX (US)

(72) Inventor: Michelle Pierre, Liberty Hill, TX (US)

(21) Appl. No.: 19/053,178

(22) Filed: Feb. 13, 2025

(51) Int. Cl. G09F 7/18

(52) U.S. Cl. CPC G09F 7/18; G09F 2007/1856; G09F 2007/1886

(57) ABSTRACT

A decorative cover for altering a visual appearance of a piece of wall art includes a front panel. The front panel includes a decorative image on an outer surface of the front panel. A perimeter wall is positioned about and integrally formed with the front panel, and extends in a direction perpendicular to the front panel. A lip is integrally formed with the perimeter wall. The lip projects inwardly from the perimeter wall such that the lip forms a perimeter pocket with the perimeter wall and the front panel. The lip has an edge surrounding an orifice. A band is connected to the edge to surround the orifice. The band includes a resilient material that is stretchable for placement of a perimeter section of a piece of wall art inside the perimeter pocket and resilient to pull the front panel taut over the piece of wall art.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to art covers and more particularly pertains to a new decorative cover for altering a visual appearance of a piece of wall art. Wall art can be pictures, paintings, sculpted pieces, and other similar decorative pieces mounted on a wall of a residential or commercial building. In some situations, such as during holiday seasons, such as Christmas, Thanksgiving, and Halloween, or during special events, such as birthdays, anniversaries, and graduations, it is desirable to decorate the wall to reflect the theme of the occasion, which decorations may not match the wall art. Instead of removing the wall art or wrapping the wall art in paper or similar, the new decorative cover allows a user to easily and temporarily alter the visual appearance of the wall art itself to achieve a desired decorative aesthetic.

### (2) Description of Related Art including information disclosed under 37 CFR 1.97 and 1.98.

The prior art relates to covers for artwork and electronics. The prior art, as best understood, does not disclose a decorative cover for altering a visual appearance of a piece of wall art that includes a front panel with a decorative image on an outer surface of the front panel. A lip projects inwardly from a perimeter wall of the decorative cover, which lip has an edge surrounding an orifice. A band is connected to the edge of the lip, which band includes a resilient material that is stretchable for placement of a perimeter section of a piece of wall art inside the decorative cover and is resilient to pull the front panel taut over a front surface of the piece of wall art.

### BRIEF SUMMARY OF THE INVENTION

An embodiment of the disclosure meets the needs presented above in a decorative cover for altering a visual appearance of a piece of wall art generally comprising a front panel. The front panel includes a decorative image on an outer surface of the front panel. A perimeter wall is positioned about and integrally formed with the front panel. The perimeter wall is positioned to extend in a direction perpendicular to the front panel. A lip is integrally formed with the perimeter wall. The lip projects inwardly from the perimeter wall in a direction parallel to the front panel such that the lip forms a perimeter pocket with the perimeter wall and the front panel. The lip has an edge surrounding an orifice. A band is connected to the edge of the lip. The band is positioned to surround the orifice. The band includes a resilient material that is stretchable for placement of a perimeter section of a piece of wall art inside the perimeter pocket and is resilient to pull the front panel taut over a front surface of the piece of wall art.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a decorative cover according to an embodiment of the disclosure.

FIG. 2 is a rear view of an embodiment of the disclosure.

FIG. 3 is a close-up side view of the embodiment of the disclosure in FIG. 2.

FIG. 4 is a side view of an embodiment of the disclosure in use.

FIG. 5 is a front view of an embodiment of the disclosure in use.

FIG. 6 is a back view of an embodiment of the disclosure in use.

FIG. 7 is a cross-sectional view of the embodiment of the disclosure in FIG. 2.

### DETAILED DESCRIPTION OF THE INVENTION

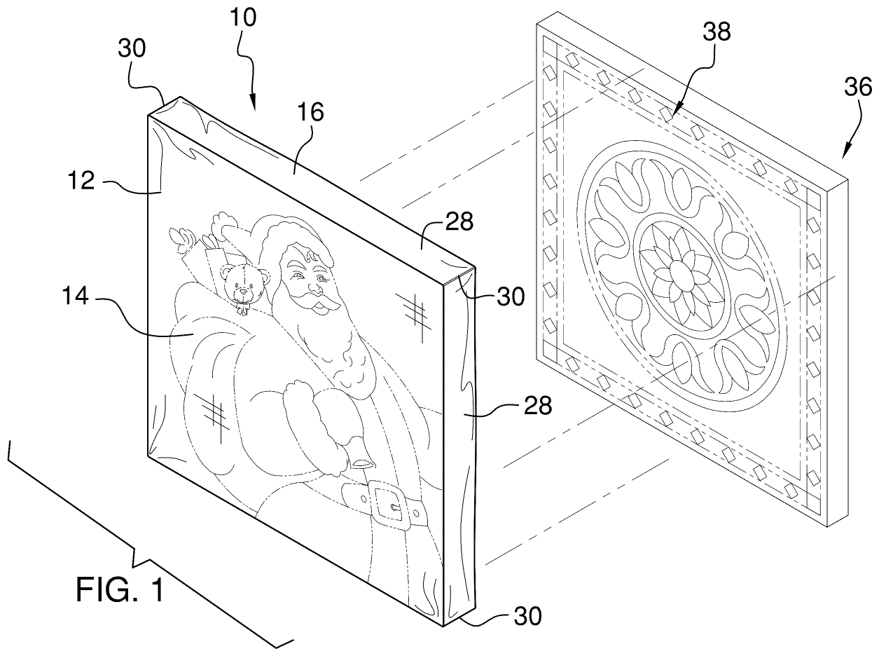

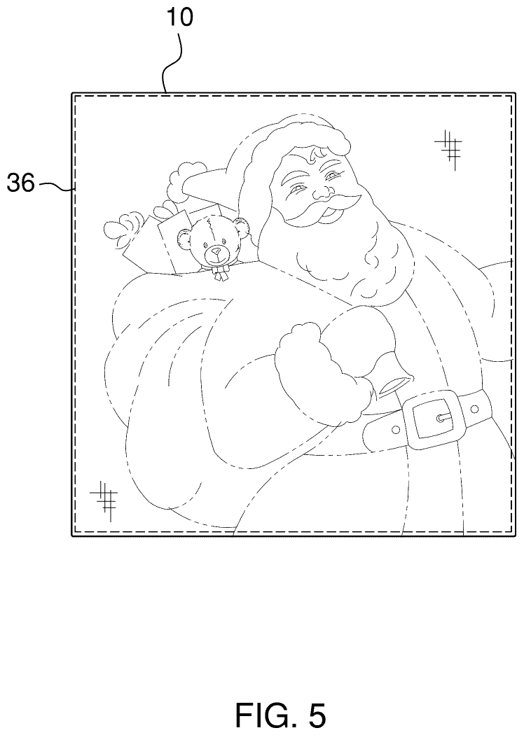

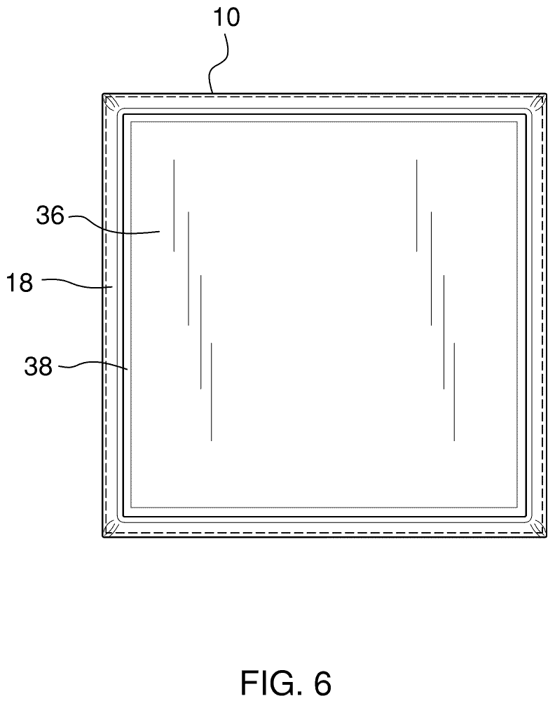

With reference now to the drawings, and in particular to FIGS. 1 through 7 thereof, a new decorative cover embodying the principles and concepts of an embodiment of the disclosure and generally designated by the reference numeral 10 will be described.

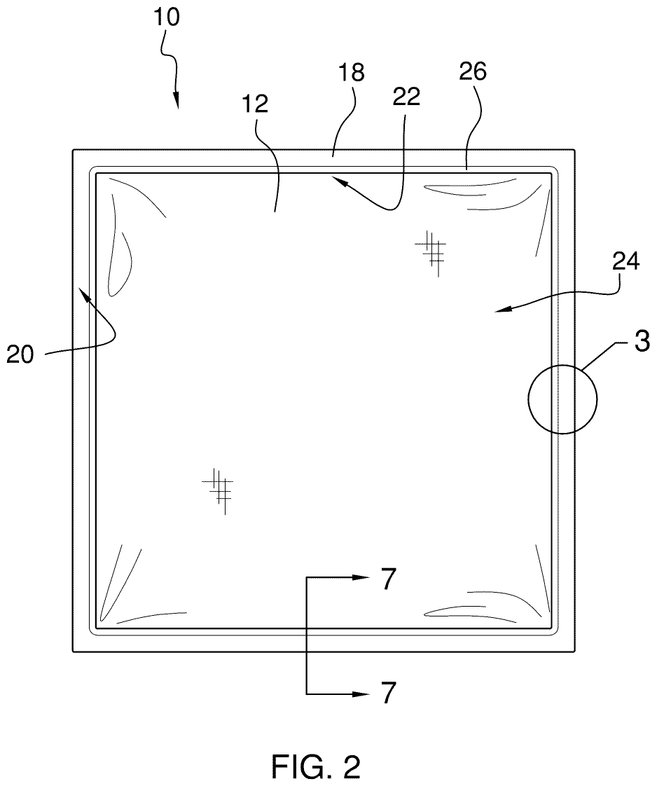

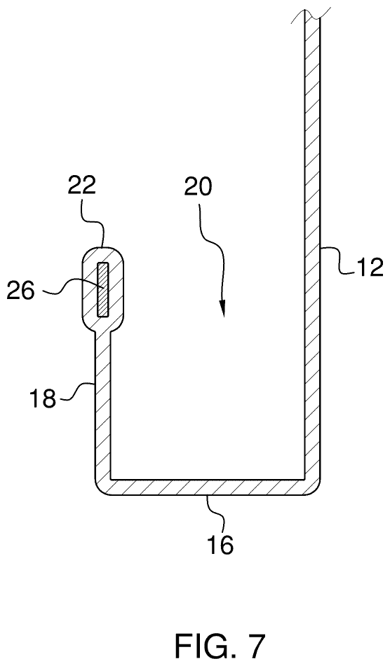

As best illustrated in FIGS. 1 through 7, the decorative cover 10 for altering a visual appearance of a piece of wall art 36 generally comprises a front panel 12. The front panel 12 includes a decorative image 14 on an outer surface of the front panel 12. A perimeter wall 16 is positioned about and integrally formed with the front panel 12. The perimeter wall 16 is positioned to extend in a direction perpendicular to the front panel 12. As shown in FIG. 2, a lip 18 is integrally formed with the perimeter wall 16. The lip 18 projects inwardly from the perimeter wall 16 in a direction parallel to the front panel 12 such that the lip 18 forms a perimeter pocket 20 with the perimeter wall 16 and the front panel 12. The lip 18 has an edge 22 surrounding an orifice 24. The perimeter pocket 20 is shown in cross-section in FIG. 7. A band 26 is connected to the edge 22 of the lip 18. The band 26 is positioned to surround the orifice 24. The band 26 includes a resilient material that is stretchable for placement of a perimeter section 38 of the piece of wall art 36 inside the perimeter pocket 20 and is resilient to pull the front panel 12 taut over a front surface of the piece of wall art 36.

Each of the front panel 12, the perimeter wall 16, and the lip 18 includes a resiliently stretchable fabric. The resiliently stretchable fabric includes nylon and polyurethane. The resiliently stretchable fabric is wrinkle-resistant. Other materials such as plastic could be used.

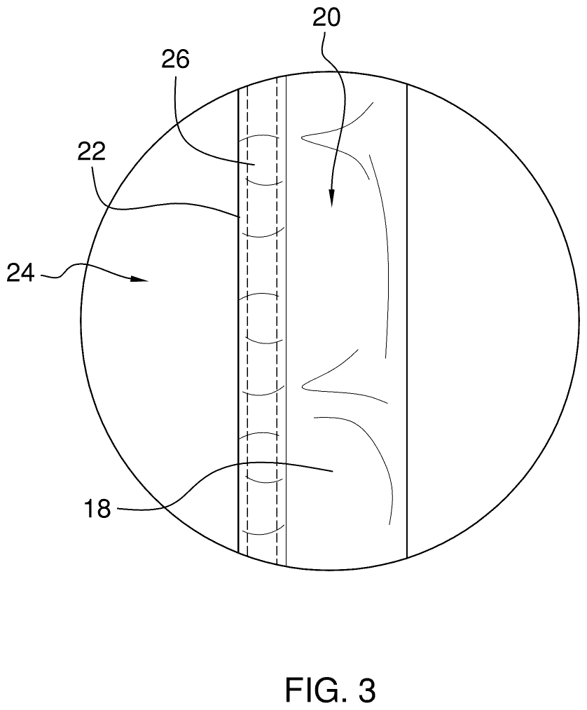

In the exemplary embodiment in FIG. 3, the band 26 includes an elastic strip positioned inside the lip 18. The elastic strip could be woven into the lip 18 or adhered with an adhesive.

The front panel 12 is rectangular or square, as shown in the exemplary embodiment. The perimeter wall 16 includes four wall sections 28 and four corners 30. The corners 30 could be formed by stitching or adhesive. Each of the four wall sections 28 is connected to a respective edge of the front panel 12. Each of the lip 18 and the orifice 24 is also rectangular or square, as shown in FIG. 2. Other shapes, such as circular or triangular, could possibly be used in another possible embodiment.

The decorative cover 10 is designed to fit over wall art of essentially any dimensions. However, most wall art does not exceed certain dimensions in order to not occupy too much area of a wall. In the exemplary embodiment, the perimeter wall 16 has a width extending from the front panel 12 of 1.0 to 2.0 inches. The lip 18 has a width extending from the perimeter wall 16 of 1.0 to 2.0 inches. The front panel 12 has a height of 10.0 to 30.0 inches and a width of 10.0 to 30.0 inches. Other sizes and dimensions outside of these ranges are within the scope of the disclosure. The wall art 36 can be such pieces as paintings, photographs, sculptured pieces, and framed pieces.

The decorative image 14 is a themed image corresponding to a holiday or special event. In the exemplary embodiment shown in FIG. 1, the decorative image 14 is related to the Christmas holiday and depicts Santa Claus. Other themed images relating to other specific holidays or events are within the scope of the disclosure.

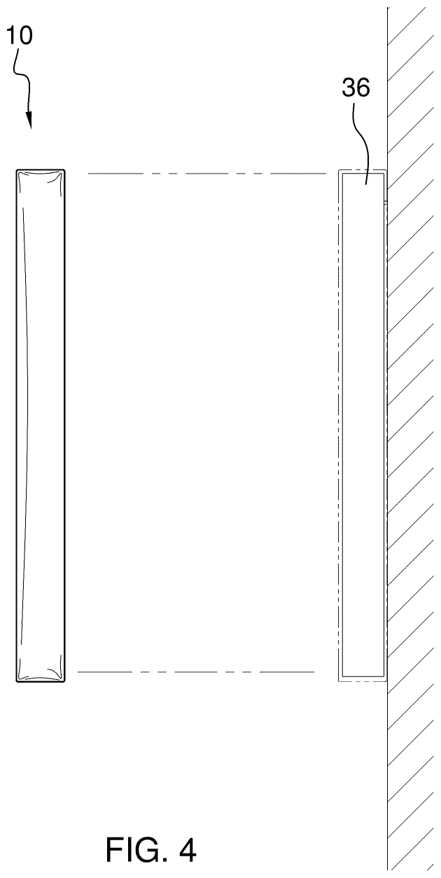

As mentioned above, the decorative cover 10 is used to alter the visual appearance of the piece of wall art 36. To do so, the user first stretches the band 26 to expand the orifice 24 to fit around the piece of wall art 36, which is larger than the orifice 24. As shown in FIGS. 4 through 6, the user then places the perimeter section 38 of the piece of wall art 36 inside the perimeter pocket 20, such that the front panel 12 extends over a front surface of the piece of wall art 36, the perimeter wall 16 extends over a perimeter surface of the piece of wall art 36, and the lip 18 extends over a perimeter portion of a back surface of the piece of wall art 36. The user releases the band 26, which thereby pulls the front panel 12 taut over the front surface of the piece of wall art 36, such that the decorative image 14 is visible. When done using the decorative cover 10, the user slips the decorative cover 10 off of the piece of wall art 36 to expose the piece of wall art 36 once again.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A decorative cover for altering a visual appearance of a piece of wall art comprising:
a front panel, said front panel including a decorative image on an outer surface of said front panel;
a perimeter wall being positioned about and integrally formed with said front panel, said perimeter wall be positioned to extend in a direction perpendicular to said front panel;
a lip being integrally formed with said perimeter wall, said lip projecting inwardly from said perimeter wall in a direction parallel to said front panel such that said lip forms a perimeter pocket with said perimeter wall and said front panel, said lip having an edge surrounding an orifice; and
a band being connected to said edge of said lip, said band being positioned to surround said orifice, said band comprising a resilient material being stretchable for placement of a perimeter section of a piece of wall art inside said perimeter pocket and being resilient to pull said front panel taut over a front surface of the piece of wall art.

2. The decorative cover of claim 1, wherein:
said front panel is rectangular;
said perimeter wall includes four wall sections and four corners;
each of said four wall sections is connected to a respective edge of said front panel;
said lip is rectangular; and
said orifice is rectangular.

3. The decorative cover of claim 2, wherein each of said front panel, said lip, and said orifice is square.

4. The decorative cover of claim 1, wherein each of said front panel, said perimeter wall, and said lip comprises a resiliently stretchable fabric.

5. The decorative cover of claim 4, wherein said resiliently stretchable fabric comprises nylon and polyurethane.

6. The decorative cover of claim 5, wherein said resiliently stretchable fabric is wrinkle-resistant.

7. The decorative cover of claim 1, wherein said band comprises an elastic strip positioned inside said lip.

8. The decorative cover of claim 1, wherein said perimeter wall has a width extending from said front panel of 1.0 to 2.0 inches.

9. The decorative cover of claim 1, wherein said lip has a width extending from said perimeter wall of 1.0 to 2.0 inches.

10. The decorative cover of claim 1, wherein said front panel has a height of 10.0 to 30.0 inches and a width of 10.0 to 30.0 inches.

11. The decorative cover of claim 1, wherein said decorative image is a themed image corresponding to a holiday or special event.

12. The decorative cover of claim 2, wherein each of said front panel, said perimeter wall, and said lip comprises a resiliently stretchable fabric.

13. The decorative cover of claim 12, wherein said resiliently stretchable fabric comprises nylon and polyurethane.

14. The decorative cover of claim 13, wherein said resiliently stretchable fabric is wrinkle-resistant.

15. The decorative cover of claim 14, wherein said band comprises an elastic strip positioned inside said lip.

16. The decorative cover of claim 15, wherein:
said perimeter wall has a width extending from said front panel of 1.0 to 2.0 inches;
said lip has a width extending from said perimeter wall of 1.0 to 2.0 inches; and
said front panel has a height of 10.0 to 30.0 inches and a width of 10.0 to 30.0 inches.

17. The decorative cover of claim 16, wherein said decorative image is a themed image corresponding to a holiday or special event.

18. A method of altering a visual appearance of a piece of wall art, said method comprising the steps of:
providing a decorative cover for altering a visual appearance of a piece of wall art comprising:
a front panel, said front panel including a decorative image on an outer surface of said front panel;
a perimeter wall being positioned about and integrally formed with said front panel, said perimeter wall be positioned to extend in a direction perpendicular to said front panel;
a lip being integrally formed with said perimeter wall, said lip projecting inwardly from said perimeter wall in a direction parallel to said front panel such that said lip forms a perimeter pocket with said perimeter wall and said front panel, said lip having an edge surrounding an orifice; and
a band being connected to said edge of said lip, said band being positioned to surround said orifice, said band comprising a resilient material being stretchable for placement of a perimeter section of a piece of wall art inside said perimeter pocket and being resilient to pull said front panel taut over a front surface of the piece of wall art;
stretching said band to expand said orifice to fit around a piece of wall art larger than said orifice;
placing a perimeter section of the piece of wall art inside said perimeter pocket, such that said front panel extends over a front surface of the piece of wall art, said perimeter wall extends over a perimeter surface of the piece of wall art, and said lip extends over a perimeter portion of a back surface of the piece of wall art; and
releasing said band and thereby pulling said front panel taut over the front surface of the piece of wall art, such that said decorative image is visible.

19. The method of claim 18, wherein said front panel is rectangular, said perimeter wall includes four wall sections and four corners, each of said four wall sections is connected to a respective edge of said front panel, said lip is rectangular, and said orifice is rectangular, and said method further comprises placing said decorative cover on a rectangular piece of wall art.
